(19) United States
(12) Patent Application Publication
(10) Pub. No.: US 2010/0292003 A1
(43) Pub. Date: Nov. 18, 2010

(54) METHOD, MAKER, SERVER, SYSTEM AND RECORDING MEDIUM FOR SHARING AND MAKING GAME IMAGE

(75) Inventor: Junghan Kim, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: BLUEHOLE STUDIO, INC., Seoul (KR)

(21) Appl. No.: 12/782,203

(22) Filed: May 18, 2010

(30) Foreign Application Priority Data
May 18, 2009 (KR) 10-2009-0043018

(51) Int. Cl. A63F 13/00; A63F 9/24

(52) U.S. Cl. 463/31; 463/42

(57) ABSTRACT

The present disclosure relates to a maker, server, method, and computer readable recording medium for making and sharing game images. The present disclosure provides a game image sharing service system comprising a creator terminal for generating a game image with receiving and then using selected symbols input from a list of indexed symbols and symbol presentation control information inputs on the selected symbols, the creator terminal also generating and transmitting game image presentation information on the generated game image; a server for receiving and storing the game image presentation information before transmitting the same in storage; and a sharer terminal for reproducing the game image based on the received game image presentation information from the server.

### TECHNICAL FIELD

The present disclosure relates to a maker, server, method, and computer readable recording medium for making and sharing game images. More particularly, the present disclosure relates to a maker, server, method and computer readable recording medium for making and sharing game images in order to allow a game user to liberally create a user's own handsome game image in high resolution to share with other users.

### BACKGROUND OF THE DISCLOSURE

Currently, online game users are making various game images individually for use in their games seeking to enhance the solidarity among the players or the gaming fun. These game images may include a distinctive online gaming identification of “guild crest” with respect to other users or guilds or online gaming images displayed as a house, wallpaper, signboard, clothe, accessory, and/or weapon among various other items.

Conventionally, to have such a game image applied to an online game, the user is supposed to custom draw the game image in a picture file before registering the same with a server, which may apply the image to the online game and also transmits it to a number of other users.

This conventional formation of the game image in picture file format necessarily increases its file size. This large size game image then significantly contributes to a heavy transmission load each time the creator attempts to make its registration with the server or when the server distributes the registered image to the different users.

And an attempt to reduce the game image file size will see a serious degradation of the image quality.

In other words, due to the facts that conventional game images were made in the picture file, which was in turn distributed as a whole for sharing among the users, the creator has been constrained to make something short of a desired handsome game image creation. This is because designing a good looking game image will only add to increasing the image data size too large to transmit.

### DISCLOSURE OF THE INVENTION

In this circumstance, one embodiment of the present disclosure is adapted to allow the user freely produce any higher resolution handsome game images to share with other users.

Also, in another aspect of the present disclosure, such a game image is adapted to be registered with and/or distributed by the server.

An embodiment of the present disclosure provides an image maker which comprises a game imager for generating a game image with receiving and then using selected symbols input from an input device among a list of symbols stored and indexed in a memory and symbol presentation control information inputs on the selected symbols; a generator for generating game image presentation information on the generated game image; and a transmitter for sending the generated game image presentation information through a communication interface.

Another embodiment of the present disclosure provides a computer readable recording medium storing a computer program for executing a method for making a game image, the computer program comprising generating the game image with receiving and then using selected symbols input from a list of indexed symbols and symbol presentation control information inputs on the selected symbols; generating game image presentation information on the generated game image; and sending the generated game image presentation information.

Yet another embodiment of the present disclosure provides a game image sharing service system comprising: a creator terminal for generating a game image with receiving and then using selected symbols input from a list of indexed symbols and symbol presentation control information inputs on the selected symbols, the creator terminal also generating and transmitting game image presentation information on the generated game image; a server for receiving and storing the game image presentation information before transmitting the same in storage; and a sharer terminal for reproducing the game image based on the received game image presentation information from the server.

Yet another embodiment of the present disclosure provides a game image sharing service provision server comprising: a receiver for receiving game image presentation information on a game image generated in an image format by a creator terminal; a storage for storing the received game image presentation information; and a transmitter for sending the stored game image presentation information to one or more sharer terminals, the game image presentation information being text information necessary to graphically reproduce the game image.

Yet another embodiment of the present disclosure provides a game image sharing service provision method comprising: receiving game image presentation information on a game image generated in an image format by a creator terminal; storing the received game image presentation information; and transmitting the stored game image presentation information to one or more sharer terminals, the game image presentation information being text information necessary to graphically reproduce the game image.

As described above, according to an embodiment of the disclosure, the user becomes enabled to liberally create a desired custom game image in a higher resolution in order to let other users share the same game image.

In addition, according to an embodiment of the disclosure in multiplayer online games, instead of transmitting the game image as a whole its presentation enabling information is arranged for transmission to significantly lessen the data amount to process in registering the game image with a server or distributing thereof.

Further, according to an embodiment of the disclosure, as individual users can create liberal game images to their tastes without the constraint of its file size, different users in the online game world may be encouraged to actively create and share quality game images.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a diagram of a game image sharing service system according to an embodiment;

FIG. 2 is a block diagram of an image maker for allowing a creation of a game image according to an embodiment;

FIG. 3 is a view for illustrating a user interface for the image maker according to an embodiment;

FIG. 4 is a view for illustrating a symbol list table used in an operation of the image maker according to an embodiment;

FIG. 5 is a view for illustrating presentation information on the game image in the image maker according to an embodiment in a table format;

FIG. 6 is a block diagram of a server for providing a game image sharing service according to an embodiment; and

FIG. 7 is a flow chart of a game image sharing service provision method according to an embodiment of the present disclosure.

### DETAILED DESCRIPTION OF THE EXEMPLARY EMBODIMENTS

Hereinafter, an exemplary embodiment of the present disclosure will be described with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Also, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

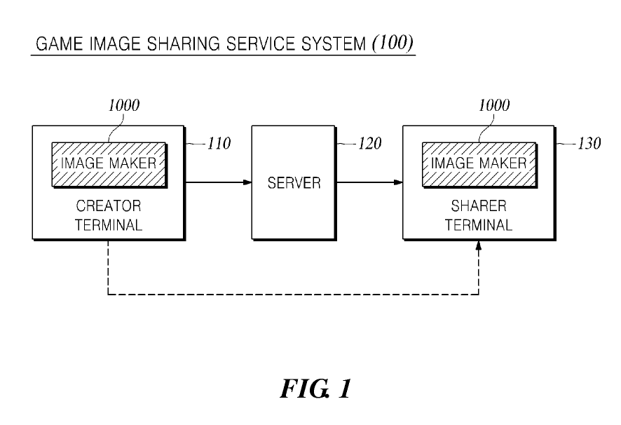

FIG. 1 is a diagram of a game image sharing service system 100 according to an embodiment of the present disclosure.

Referring to FIG. 1, the game image sharing service system 100 comprises a creator terminal 110 for generating a game image with receiving and then using selected symbols input from a list of indexed symbols and symbol presentation control info inputs on the selected symbols, the creator terminal 110 further generating and transmitting game image presentation info on the generated game image; a server 120 for receiving and storing the game image presentation info before transmitting the same in storage to a sharer terminal 130; and the sharer terminal 130 for reproducing the game image based on the received game image presentation info from the server 120.

The creator terminal 110 has an image maker 1000 used to create the game image, and in order to permit uses thereof by other users or sharers it provides the server 120 with game image presentation info to enable a presentation of the game image rather than the image itself. After or during the creation of the game image based on symbol inputs by the user selection from a list of indexed symbols and the corresponding symbol presentation control info inputs by the user manipulation, the creator terminal 110 may generate the “game image presentation information”, which includes “text information on the index numbers of the symbols” that were used in the creation of the game image and “text information on the symbol presentation control information”.

The “game image” as referred to in the present disclosure may be various game images made individually by the users for use in their games seeking to enhance the solidarity among the players or the gaming fun, and it may include one or more of a picture, symbol and character. These game images may be any images that are available for use in online games and may be represented for example by a distinctive online gaming identification of “guild crest or guild image” of flags or marks with respect to other users or guilds or online gaming images displayed as a house, wallpaper, signboard, clothe, accessory, and/or weapon among various other items.

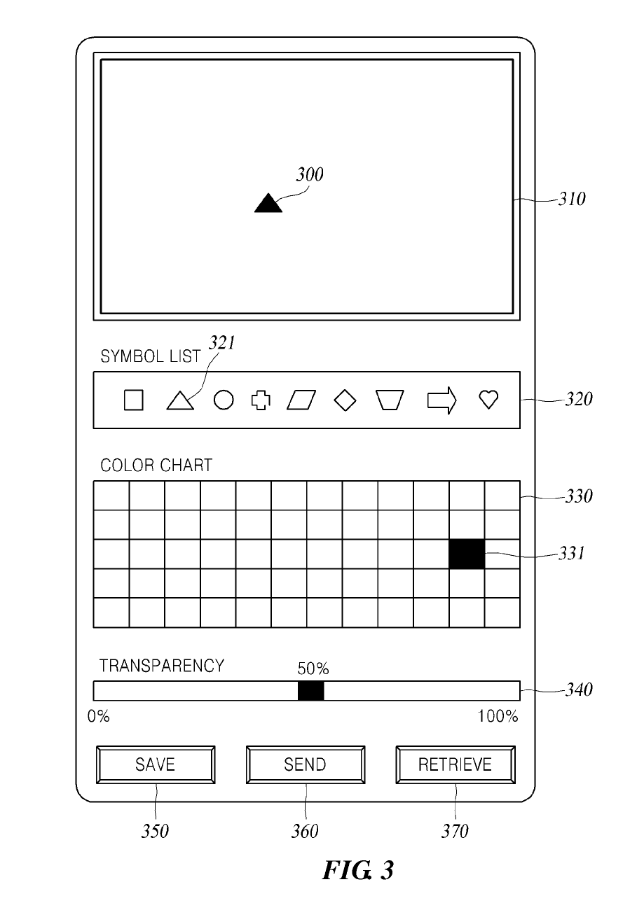

In order to create a game image by selecting desired symbols and developing them on an interface in a custom shape and color, when the user activates the image maker 1000 having a user interface illustrated in FIG. 3 to manipulate selected one or more of a symbol position, size, rotation, color, and transparency, the image maker 1000 may generate text information for one or more of a position control info, size control info, rotation control info, color control info, and transparency control info of the selected symbol and the “text information on the symbol presentation control information”, which includes the thus generated text information.

When creating the “game image” comprising one or more symbols, the associated “game image presentation info” as explained above tells how many symbols were used and what changes were affected by the user to the used symbols in the various aspects including the position, size, rotation, color, and transparency which enable an informed graphical reproduction of the game image.

The above “list of indexed symbols” may be commonly defined and stored in the creator terminal 110 and the sharer terminal 130 and the “game image presentation info” may be commonly defined between the terminals 110 and 130.

Thus, the creator terminal 110 and the sharer terminal 130 may be provided with the respective image makers 1000, which are used as tools for making game images and others so that the image maker 1000 of the sharer terminal 130 may receive the created game image in the image maker 1000 of the creator terminal 110 to correctly recognize the game image presentation info and thus reproduce the game image as originally created by the image maker 1000 of the creator terminal 110. Such image makers 1000 may be distributed among associated groups and businesses for installations in the terminals 110, 130 in the form of computer readable recording media storing a computer program for executing a method for making the game image, or instead they may be electronically downloaded via the server 120 or a different server onto the creator terminal 110 and the sharer terminal 130.

Although FIG. 1 illustrates that the server 120 relays the game image presentation info received from the creator terminal 110 to a single sharer terminal 130, a multitude of similar sharer terminals may receive the transmission of the same presentation info according to the present disclosure.

In addition, the creator terminal 110 and the sharer terminal 130 as shown in FIG. 1 may be interconnected through a wired/wireless communication network, which may be the Internet or a network to interconnect the creator terminal 110, sharer terminal 130, and server 120, and alternatively if one or both of the terminals 110, 130 is/are a mobile communication terminal(s) the wired/wireless communication network may include a mobile communication network.

The above explained “game image sharing” may be a “client/server sharing method” wherein the game image presentation info of the game image from the image maker 1000 of the creator terminal 110 is provided via the server 120 to the sharer terminals 130 to accomplish the sharing. In other words, the client/server sharing method allows the sharing of the game image that the creator terminal 110 made with the maker 1000 by sending the game image presentation info to the server 120, which then relays the same to the sharer terminals 130, which eventually take in the game image representation info from the server 120 and develop it to a usable reproduction of the created game image in the maker 1000 of the creator terminal 110.

However, besides the client/server sharing method, a p2p or peer-to-peer sharing may be carried out according the present disclosure where the game image may be shared when the creator terminal 110 offers the sharer terminal 130 directly without passing the server 120.

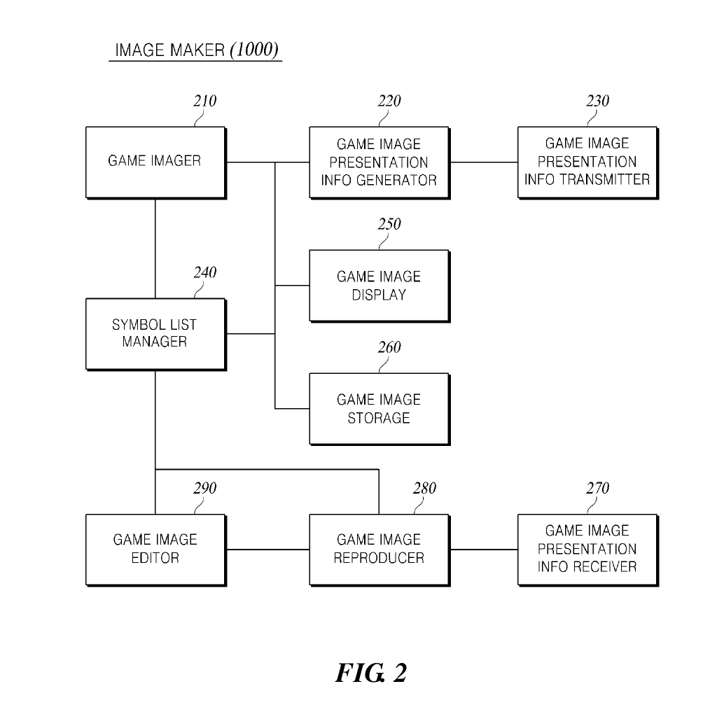

As to the versatile tool of image maker 1000 installed in the sharer terminal 130 as well as the creator terminal 110 to have the game image made, send/receive the game image presentation info to let the image viewed for sharing, and reconstruct the received game image presentation info, more detailed explanation will be provided referring to FIG. 2.

FIG. 2 is a block diagram of the image maker 1000 for allowing a creation of a game image according to an embodiment.

In FIG. 2, the image maker 1000 comprises a game imager 210 for generating a game image with receiving and then using user selected symbols input from an input device among a list of symbols stored and indexed in a memory and symbol presentation control info inputs for the selected symbols; a generator 220 for generating game image presentation info on the generated game image; and a transmitter 230 for sending the generated game image presentation info through a communication interface.

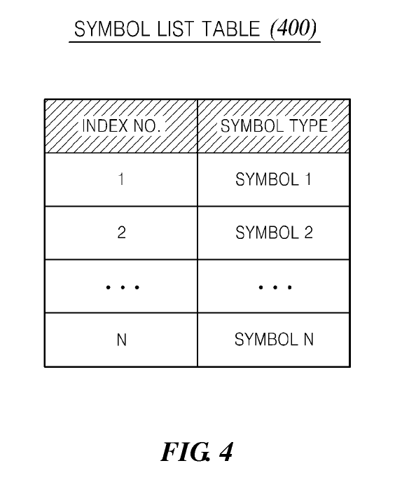

Also in FIG. 2, the above maker 1000 also includes a symbol list manager 240, which stores and manages the symbol list having one or more indexed symbols with index numbers. Here, the symbol list may be stored for management in the form of a symbol list table (see FIG. 4) where the number of the symbols is predetermined while it is possible to add, delete, or make changes to and from the included symbols via the server 120.

In order to create a game image by selecting desired symbols and developing them on an interface in a custom shape and color, the above mentioned “symbol presentation control info inputs” have been caused from manipulating one or more aspects of the position, size, rotation, color, and transparency of the respective symbols through the user interface of the image maker 1000 as in FIG. 3, and they may include one or more of the position control info, size control info, rotation control info, color control info, and transparency control info.

The above game imager 210 may produce the game image in a vector image format using the initial symbol inputs by the user selection on the user interface of the image maker 1000 as in FIG. 3 and the subsequent symbol presentation control info inputs by the user manipulation on the same user interface of one or more of the position, size, rotation, color, and transparency of the symbol inputs. In generating the game image, the game imager 210 may reference to the symbol list table of FIG. 4 which is stored in and under management of the symbol list manager 240.

Herein, the vector image is a format or type of presenting an image as compared to a bitmap image. The bitmap image comprises a group of dots as a way to express images which are appropriate for photos and paintings and superior in image transitions, but has shortcomings that it is voluminous and susceptible to damages in image scaling with zoom in/out. In contrast, the vector image only stores values (information) of, for example lines and colors and then makes a presentation through a processor that executes a floating-point calculation (a numerical combination) which is appropriate for characters, logos, character designs and such, and is advantageous in that it is small in file size and its enlargement or reduction does not affect the image quality. Due to this advantage, the vector image format is preferred in making the game image according to an embodiment of the present disclosure.

As described above, once the game image is produced (made) in the game imager 210, the sharing of the image is not realized with delivering the game image (vector image) itself thru the server 120 to the sharer terminal 130 but by providing the sharer terminal 130 directly or thru the server 120 with text format information i.e., the game image presentation info which can be recognized by the sharer terminal 130 to reproduce the game image.

This indirect sharing of the game image though the text format of the game image presentation info adapted to be recognized by the sharer terminal 130 is advantageous because of the significant reduction of the file size from transmitting the game image itself.

Therefore, the generator 220 operates to generate the game image presentation info, which contains the text information on the index numbers of the symbol inputs by the user selection on the user interface (FIG. 3) of the image maker 1000 and the text information on the corresponding symbol presentation control info inputs by the user manipulations of the symbol position, size, rotation, color, and transparency, etc on the same user interface of the image maker 1000.

Referring to FIG. 2, the image maker 1000 may comprise one or more of a game image display 250 for displaying the generated game image and a game image storage 260 for storing the generated game image and/or the presentation information of the generated game image.

Since both the creator terminal 110 and the sharer terminal 130 have a common image production tool of the image maker 1000 installed therein, the sharer terminal 130 may have its own image maker 1000 reproduce the original game image off the received game image presentation information from the creator terminal 110.

Thus, considering the sharer terminal 130 has the common image maker 1000 installed to share the received game image presentation info from the creator terminal 110, the image maker 1000 may be made to further include a receiver 270 for receiving the game image presentation info transmitted from the creator terminal 110 either directly or via the server 120 and a game image reproducer 280 for reproducing the game image based on the game image presentation info in receipt rather than the game image itself, as shown in FIG. 2.

In this case, the image maker 1000 may further comprise a game image editor 290 for editing the reproduced game image in the game image reproducer 280 with receiving and utilizing the current symbol inputs by the user selection from the list of stored symbols and the corresponding symbol presentation control info inputs.

On the other hand, the image maker 1000 may limit the number of times a particular game image being shared by having the game image presentation info on the generated game image registered with the server 120 before distributing the same to other users (sharers) and counting under management the number of sharing the corresponding game image.

In addition, the image maker 1000 may check the qualification or level of the involved user in the online game who is the user of the maker 1000 to control the registration of the game image presentation info for the generated game image created by that user. For example, it is possible to control that gold level users may register the game image presentation info on their game image creations exclusively.

Additionally, the image maker 1000 may perform a function to clearing out lately unused game images in a predetermined rule such as by order of time and size.

Also, when storing the game image, the image maker 1000 may change the format thereof.

The above disclosed method of making the game image according to an embodiment may be implemented in a computer readable recording medium storing a computer program for executing the method.

The computer program of the present method of making the game image may implement generating the game image with receiving and then using selected symbols input from a list of indexed symbols and symbol presentation control information inputs on the selected symbols; generating game image presentation information on the generated game image; and sending the generated game image presentation information.

The computer readable media recorded with computer program to implement the present method of making the game image may comprise any kinds of recording devices for recording data readable by computers.

Examples of such computer readable recording media include ROM, RAM, CD-ROM, magnetic tapes, floppy discs, and optical data storages, and further comprise an implementation in carrier waves (e.g. transmission over the Internet). In addition, the computer readable recording media may be provided in a distributed processing system where computer systems are networked to store and execute computer readable codes at distributed locations. Furthermore, functional programs, codes, and code segments to implement the disclosed embodiments may be easily deduced by programmers skilled in the art thereof.

FIG. 3 is a view for illustrating the user interface for the image maker 1000 according to an embodiment of the disclosure.

Referring to FIG. 3, upon installation of the image maker 1000 in the creator terminal 110, the creator will be able to view the exemplified user interface or UI, which may comprise a symbol selection UI 320 for displaying a list of the symbols provided by the image maker 1000 to permit the selection of a specific symbol at 321, a color selection UI of a color chart 330 containing a variety of colors from which a particular color at 331 may be selected, and a transparency adjust UI 340 to enable the transparency of the selected color 331.

In this way, when the color 331 and transparency (for example, 50%) are determined for the particular selected symbol 321, a symbol 300 with the color 331 and the transparency of 50% may be viewed on a display 310, and it can be controlled by the user in movement to a desired position or a symmetrical position, enlargement/reduction to a desired size, and rotation to a desired orientation. This manipulation of the symbols 300 by the user on the display 310 thru the changes in position, location, or orientation may create one or more of the symbol's positional control info, size control info, and rotational control info. Thus created positional, size, and/or rotational control info plus one or both of color control info and transparency control info following a user setting of the color and/or the transparency causes a generation of symbol presentation control info.

Repeated occurrences of the above described symbol presentation control info and their combination can make a game image in a vector image format.

To serve the user wishing to store the newly made game image, there is a save button 350 to click. To assist the user to share the game image made with other users, a send button 360 is provided and if clicked it will send the game image presentation info on the new game image to destinations including the associated server 120 and the connected sharer terminal 130.

In addition, if the user wishes to fetch the stored game image (or the game image presentation info) from the terminal (the creator terminal 110 or sharer terminal 130), or if one user (sharer) wishes to use other's (creator's) created game image as it is or revised, the sharer may click a retrieve button 370 on the user interface of the image maker 1000 installed in the sharer terminal 130 to retrieve the game image presentation info of the game image of choice.

FIG. 4 is a view for illustrating an exemplified symbol list table 400 having various indexed symbols used in an operation of the image maker 1000 according to an embodiment. As shown in FIG. 4, the symbol list table 400 may comprise available symbol types of symbol 1, symbol 2, . . . , symbol N and the symbol's unique index numbers of 1, 2, . . . , N.

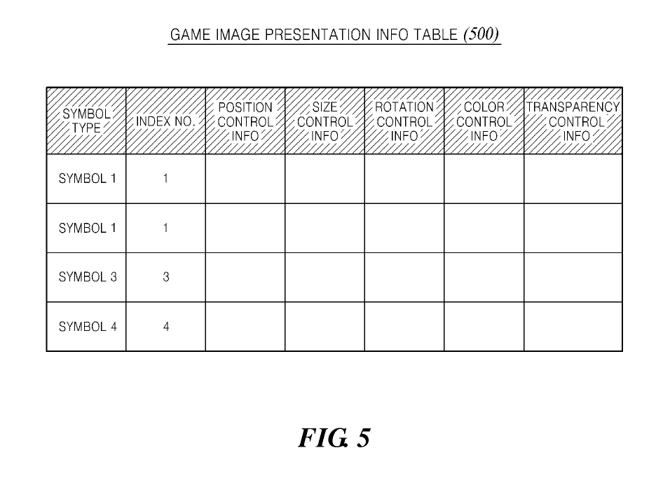

FIG. 5 is a view for illustrating presentation information on the game image from the image maker 1000 according to an embodiment in a table format 500.

The game image presentation info table 500 exemplified in FIG. 5 is a table containing the ready to transmit game image presentation info to enable a sharing of the created game image which shows the types of the used symbols in making the game image were symbol 1 thru 4 as well as the index numbers of the respective symbols and each symbol's symbol presentation control info (for example, position control info, size control info, rotation control info, color control info, and transparency control info).

The index numbers of the respective symbols and each symbol's symbol presentation control info are in a text format, which is commonly recognizable by the image maker 1000 in the creator terminal 110 and the image maker 1000 in the sharer terminal 130.

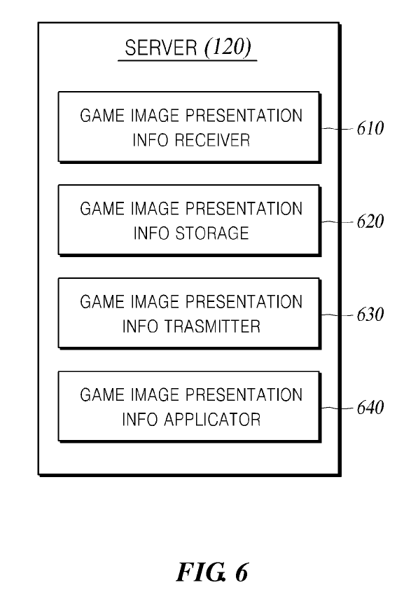

FIG. 6 is a block diagram of a server 120 for providing a game image sharing service according to an embodiment.

Referring to FIG. 6, the game image sharing service server 120 may comprise a game image presentation info receiver 610 for receiving the presentation info on the game image in the image format as generated by the creator terminal 110, game image presentation info storage 620 for storing the received presentation info, and a game image presentation info transmitter 630 for sending the stored presentation info to one or more sharer terminals 130.

The above referenced game image presentation info may be text information necessary to graphically reproduce the game image and comprises the text information on the index number of the symbol as used in creating the game image and the text information on the used symbol's presentation control info.

The above game image presentation info transmitter 630 may either respond to a request from one or more sharer terminals 130 for the stored game presentation info for transmitting the same or arbitrarily select one or more sharer terminals 130 to send the stored game presentation info with no request from a particular sharer terminal 130.

Referring to FIG. 6, the server 120 may further comprise a game image applicator 640, which based on the game image presentation info received from the creator terminal 110 controls the corresponding game image of that game image presentation info to be displayed on specific items of the associated online game.

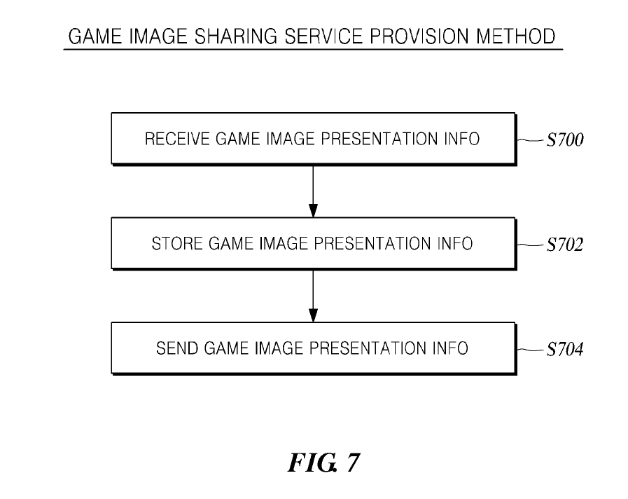

FIG. 7 is a flow chart of a game image sharing service provision method according to an embodiment of the present disclosure.

Referring to FIG.7, the present game image sharing service provision method may comprise receiving game image presentation information on a game image generated in an image format by a creator terminal in step S700; storing the received game image presentation information in step S702; and transmitting the stored game image presentation information to one or more sharer terminals in step S704.

The above mentioned game image presentation information is text information to allow a graphical reproduction of the game image.

As described above, according to an embodiment of the disclosure, the user becomes enabled to liberally create a desired custom game image in a higher resolution in order to let other users share the same game image.

In addition, according to an embodiment of the disclosure in multiplayer online games, instead of transmitting the game image as a whole its presentation information is transmitted instead to significantly lessen the data amount to process in registering the game image with a server or distributing thereof.

Further, according to an embodiment of the disclosure, as individual users can create liberal game images to their tastes without much constraint of its file size, different users in the online game world may be encouraged to actively create and share quality game images.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Also, every one of the components may be implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the embodiments of the present disclosure. As the computer readable media, the candidates include magnetic recording media, optical recording media, and carrier wave media.

Also, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes. Accordingly, the scope of the disclosure is not to be limited by the above embodiments but by the claims and the equivalents thereof.

What is claimed is:

1. A game image sharing service system comprising:
a creator terminal for generating a game image with receiving and then using selected symbols input from a list of indexed symbols and symbol presentation control information inputs on the selected symbols, the creator terminal also generating and transmitting game image presentation information on the generated game image;
a server for receiving and storing the game image presentation information before transmitting the same in storage; and
a sharer terminal for reproducing the game image based on the received game image presentation information from the server.

2. The game image sharing service system in claim 1, wherein the list of indexed symbols is commonly defined and stored in the creator terminal and the sharer terminal, and the game image presentation information is commonly defined between the creator terminal and the sharer terminal.

3. A game image sharing service provision server comprising:
a receiver for receiving game image presentation information on a game image generated in an image format by a creator terminal;
a storage for storing the received game image presentation information; and
a transmitter for sending the stored game image presentation information to one or more sharer terminals, the game image presentation information being text information necessary to graphically reproduce the game image.

4. The game image sharing service provision server in claim 3, wherein the game image presentation information contains text information on the index number of the symbol as used in creating the game image and the text information on the used symbol's presentation control info.

5. The game image sharing service provision server in claim 3, wherein game image presentation info transmitter either responds to a request from one or more sharer terminals for the stored game presentation info for transmitting the same or arbitrarily select one or more sharer terminals to send the stored game presentation info.

6. The game image sharing service provision server in claim 3 further comprising a game image applicator, which based on the game image presentation info received controls the game image to be displayed on specific items of an associated online game.

7. A game image sharing service provision method comprising:
receiving game image presentation information on a game image generated in an image format by a creator terminal;
storing the received game image presentation information; and
transmitting the stored game image presentation information to one or more sharer terminals, the game image presentation information being text information necessary to allow graphically reproduce the game image.

8. A computer readable recording medium storing a computer program for executing a method for making a game image, the computer program comprising:
generating the game image with receiving and then using selected symbols input from a list of indexed symbols and symbol presentation control information inputs on the selected symbols;
generating game image presentation information on the generated game image; and
sending the generated game image presentation information.

9. An image maker comprising:
a game imager for generating a game image with receiving and then using selected symbols input from an input device among a list of symbols stored and indexed in a memory and symbol presentation control information inputs on the selected symbols;
a generator for generating game image presentation information on the generated game image; and
a transmitter for sending the generated game image presentation information through a communication interface.

10. The image maker in claim 9, further comprising a symbol list manager, which stores and manages the symbol list having one or more indexed symbols with index numbers.

11. The image maker in claim 9, wherein the symbol presentation control info inputs include one or more of the position control information, size control information, rotation control information, color control information, and transparency control information.

12. The image maker in claim 9, wherein the game imager produces the game image in a vector image format using the symbol inputs and the symbol presentation control info inputs.

13. The image maker in claim 9, wherein the game image presentation information generator operates to generate the game image presentation info, which contains the text information on the index numbers of the symbol inputs and the text information on the symbol presentation control info inputs.

14. The image maker in claim 9, further comprising one or more of a game image display for displaying the generated game image and a game image storage for storing the generated game image and/or the presentation information of the generated game image.

15. The image maker in claim 9, further comprising a receiver for receiving game image presentation information from an external source and a game image reproducer for reproducing the game image based on the external game image presentation information in receipt.

16. The image maker in claim 15, further comprising a game image editor for editing the reproduced game image with receiving and utilizing the current symbol inputs selected from the list of stored symbols and the corresponding symbol presentation control information inputs.
